(19) United States
(12) Patent Application Publication
(10) Pub. No.: US 2014/0136054 A1
(43) Pub. Date: May 15, 2014

(54) VEHICULAR IMAGE SYSTEM AND DISPLAY CONTROL METHOD FOR VEHICULAR IMAGE

(71) Applicant: Avisonic Technology Corporation, Hsin-Chu (TW)

(72) Inventor: Ching-Ju Hsia, Taipei City (TW)

(21) Appl. No.: 13/919,000

(22) Filed: Jun. 17, 2013

(30) Foreign Application Priority Data
Nov. 13, 2012 (TW) 101142206

(51) Int. Cl. G06F 3/0484

(52) U.S. Cl. CPC G06F 3/04845
USPC 701/42; 701/36

(57) ABSTRACT

A vehicular image system includes a display unit, an image capture unit, a sensing receiving unit, a gesture recognition unit and a processing unit. The image capture unit is arranged to receive a plurality of sub-images. The sensing receiving unit is arranged to detect a sensing event to generate detection information. The gesture recognition unit is coupled to the sensing receiving unit, and is arranged to generate a gesture recognition result according to the detection information. The processing unit is coupled to the image capture unit and the gesture recognition unit, and is arranged to generate a vehicular image according to the sub-images and control a display of the vehicular image on the display unit according to the gesture recognition result.

### BACKGROUND OF THE INVENTION

1. Field of the Invention

The disclosed embodiments of the present invention relate to a vehicular image system, and more particularly, to a vehicular system, which controls a display of a two-dimensional/three-dimensional vehicular image by using a touch apparatus (e.g. a capacitive multi-point touch panel) or a non-contact/non-touch optical sensor to determine a gesture, and a related control method.

2. Description of the Prior Art

A vehicular image of an around view monitor (AVM) system is usually at a fixed viewing angle/position (i.e. a bird's-eye view image) and the vehicle image is at the center of the screen. The user cannot adjust the viewing angle/position of the vehicular image. One conventional solution uses a joystick or a keypad to control the display of the vehicular image. Either of these devices will increase the overall cost, however, as well as providing inconvenient control. In addition, as the joystick is a mechanical device, it has a high failure probability and a short product life, and needs additional disposition space. The joystick may be broken in a car accident, which increases the risk of hurting passengers of the vehicle. Moreover, the display modes and information for the driver are limited to using the mechanical device or the keypad, which cannot meet the requirements of a next generation vehicular image system

Regarding the above problems, a novel vehicular image system, wherein the driver can obtain any view angle of a vehicular image and control the image easily, will improve safety on the road.

### SUMMARY OF THE INVENTION

It is one objective of the present invention to provide a vehicular system, which controls a display of a vehicular image by using a touch apparatus or a non-contact optical sensor to determine a gesture, and a related control method to solve the above problems.

According to an embodiment of the present invention, an exemplary vehicular image system is disclosed. The exemplary vehicular image system comprises a display unit, an image capture unit, a sensing receiving unit, a gesture recognition unit and a processing unit. The image capture unit is arranged to receive a plurality of sub-images from cameras. The sensing receiving unit is arranged to detect a sensing event to generate detection information. The gesture recognition unit is coupled to the sensing receiving unit, and is arranged to generate a gesture recognition result (i.e. recognition information of a gesture) according to the detection information. The processing unit is coupled to the image capture unit and the gesture recognition unit, and is arranged to generate a vehicular image according to the sub-images and control a display (e.g. a display mode and/or a view angle) of the vehicular image on the display unit according to the result of the gesture recognition unit (i.e. the gesture recognition result).

According to an embodiment of the present invention, an exemplary display control method for a vehicular image is disclosed. The exemplary display control method comprises the following step: receiving a plurality of sub-images; generating the vehicular image according to the sub-images; detecting a sensing event to generate detection information; generating a gesture recognition result according to the detection information; and controlling a display (e.g. a display mode and/or a view angle) of the vehicular image according to the gesture recognition result.

The proposed vehicular image system which controls the view angle of the vehicle image may not only provide a convenient operating experience for the user but also provide display of objects from any view angle. The proposed vehicular image system may be installed in the vehicle with almost no additional cost and extra space requirement.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an exemplary generalized vehicular image system according to an embodiment of the present invention.

FIG. 2 is a diagram illustrating an exemplary vehicular image system according to a first embodiment of the present invention.

FIG. 3 is a diagram illustrating an exemplary screen layout of the display unit shown in FIG. 2 according to an embodiment of the present invention.

FIG. 4 is a diagram illustrating an exemplary display zoom-in/out control of a vehicular image according to a first embodiment of the present invention using gestures.

FIG. 5 is a diagram illustrating an exemplary display rotation control of a vehicular image according to a second embodiment of the present invention using gestures.

FIG. 6 is a diagram illustrating an exemplary display shifting control of a vehicular image according to a third embodiment of the present invention using gestures.

FIG. 7 is a diagram illustrating an exemplary display tilt control of a vehicular image according to a fourth embodiment of the present invention using gestures.

FIG. 8 is a flow chart of an exemplary display control method using a touch panel for a vehicular image according to an embodiment of the present invention.

FIG. 9 is a diagram illustrating an exemplary vehicular image system according to a second embodiment of the present invention.

FIG. 10 is a flow chart of an exemplary display control method using an optical sensing unit for a vehicular image according to an embodiment of the present invention.

### DETAILED DESCRIPTION

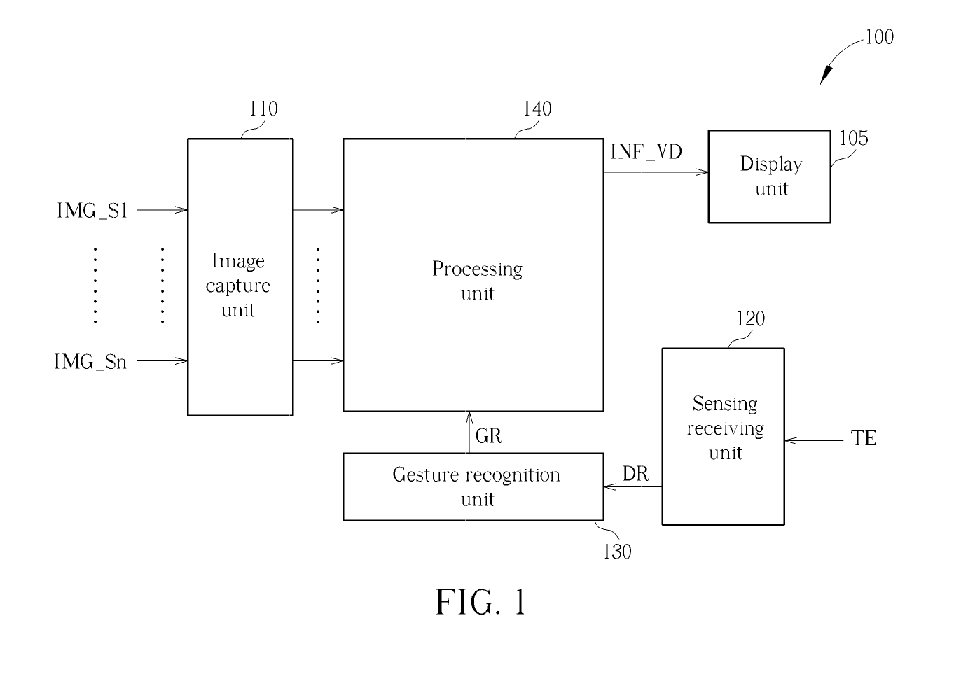

Please refer to FIG. 1, which is a diagram illustrating an exemplary generalized vehicular image system according to an embodiment of the present invention. As shown in FIG. 1, the vehicular image system may include a display unit 105, an image capture unit 110, a sensing receiving unit 120, a gesture recognition unit 130 and a processing unit 140. The gesture recognition unit 130 is coupled to the sensing receiving unit 140, and the processing unit 140 is coupled to the image capture unit 110 and the gesture recognition unit 130. First, the image capture unit 110 may receive a plurality of sub-images IMG_S1-IMG_Sn (e.g. a plurality of wide-angle distortion images), and the processing unit 140 may generate a vehicular image (e.g. a 360° around view monitor (AVM) image) according to the sub-images IMG_S1-IMG_Sn. More specifically, the processing unit 140 may perform a geometric transformation (e.g. a wide-angle image distortion correction and a top-view transformation) upon the sub-images IMG_S1-IMG_Sn to generate a plurality of corrected images, respectively, and synthesize (e.g. image stitching) the corrected images to generate the 360° AVM vehicular image. After generating the vehicular image, the processing unit 140 may transmit corresponding vehicular display information INF_VD to the display unit 105, wherein the vehicular display information INF_VD may include the vehicular image and associated display messages (e.g. parking assist graphics). In an alternative design, the processing unit 140 may further store a vehicle image, and synthesize the sub-images IMG_S1-IMG_Sn and the stored vehicle image to generate a vehicular image including the vehicle image and a 360° AVM image.

When a sensing event TE (e.g. a user's gesture) occurs, the sensing receiving unit 120 may detect the sensing event TE to generate detection information DR, and the gesture recognition unit 130 may generate a gesture recognition result GR (i.e. a recognition information of gesture) according to the detection information DR. Next, the processing unit 140 may control a display (e.g. a display mode and/or a view angle) of the vehicular image on the display unit 105 according to the gesture recognition result GR (i.e. updating the vehicular display information INF_VD). Please note that the sensing receiving unit 120 may be a motion capture device for capturing gestures. For example, the sensing receiving unit 120 may be a contact touch-receiving unit (e.g. a capacitive multi-point touch panel) or a non-contact sensing receiving unit (e.g. an infrared proximity sensor).

In one implementation, the processing unit 140 may perform a corresponding operation (e.g. an image object attribute changing operation or a geometric transformation) directly upon the vehicular image according to the gesture recognition result in order to control the display of the vehicular image on the display unit 105. For example, the processing unit 140 may change a color of a selected object in the vehicular image according to the gesture recognition result GR (e.g. an object selection gesture). Additionally, the processing unit 140 may also adjust a display range of the vehicular image according to the gesture recognition result GR (e.g. a drag gesture). In another implementation, the processing unit 140 may first perform a corresponding operation (e.g. a geometric transformation) upon the sub-images IMG_S1-IMG_Sn according to the gesture recognition result GR, and then synthesize the transformed sub-images IMG_S1-IMG_Sn to control the display of the vehicular image on the display unit 105. Please note that the aforementioned geometric transformation may be a zoom-in operation, a zoom-out operation, a rotation operation, a shifting operation, a tilt operation or a viewing angle/position changing operation.

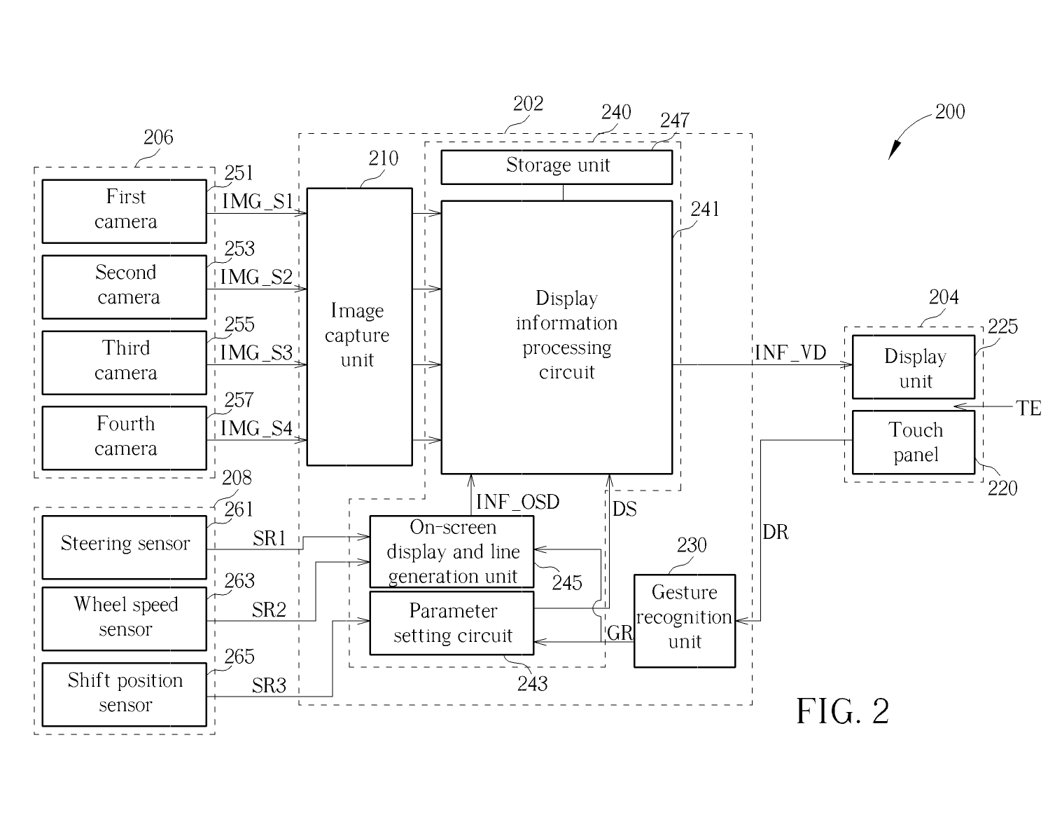

Please refer to FIG. 2 for a better understanding of the vehicular image system 100 shown in FIG. 1. FIG. 2 is a diagram illustrating an exemplary vehicular image system according to a first embodiment of the present invention. The vehicular image system 200 may include an electronic control unit (ECU) 202, a human machine interface 204, a camera apparatus 206 and a sensor apparatus 208. The ECU 202 may receive a plurality of sub-images IMG_S1-IMG_S4 provided by the camera apparatus 206 and a plurality of sensing results SR1-SR3 provided by the sensor apparatus 208, and accordingly output the vehicular display information INF_VD to the human machine interface 204. Once the user/driver performs gesture(s) upon the human machine interface 204, the ECU 202 may update the vehicular display information INF_VD according to the detection information DR.

In this embodiment, the camera apparatus 206 includes a plurality of cameras 251-257, which are arranged to capture the sub-images IMG_S1-IMG_S4 around the vehicle, respectively (e.g. a plurality of wide-angle images respectively corresponding to the front, rear, left and right of the vehicle). The sensor apparatus 208 includes a steering sensor 261, a wheel speed sensor 263 and a shift position sensor 265. The ECU 202 includes an image capture unit 210, a gesture recognition unit 230 and a processing unit 240, wherein the processing unit 240 may include a display information processing circuit 241, a parameter setting circuit 243, an on-screen display and line generation unit 245 and a storage unit 247. A default display generation using the above devices is described as follows.

First, the image capture unit 210 may receive the sub-images IMG_S1-IMG_S4 and transmit them to the display information processing circuit 241. The steering sensor 261 may detect a turn angle of the vehicle (e.g. a turn angle of the wheel) to generate the sensing result SR1, and the on-screen display and line generation unit 245 may generate display information of predicted course(s) (e.g. parking assist graphics) according to the sensing result SR1. The wheel speed sensor 263 may detect a wheel rotation speed to generate the sensing result SR2, and the on-screen display and line generation unit 245 may generate display information of the current vehicle speed according to the sensing result SR2. Hence, the display information processing circuit 241 may receive the on-screen display information INF_OSD including the prediction course(s) and the vehicle speed.

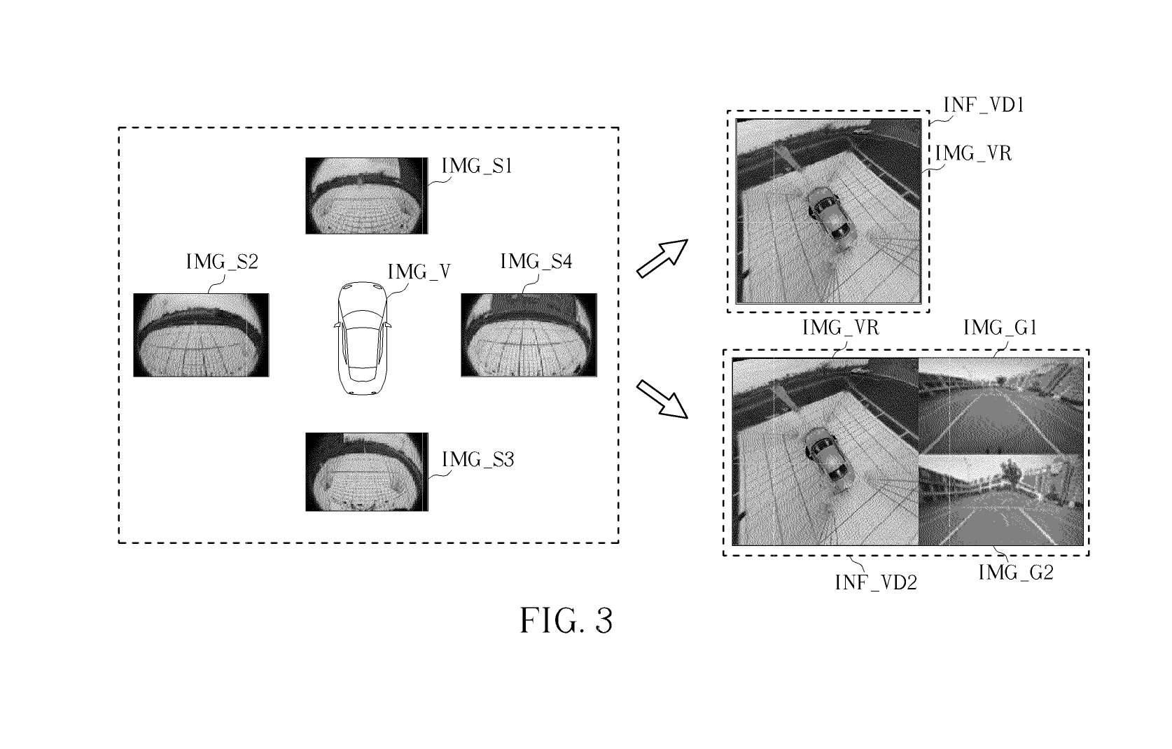

The shift position sensor 265 may detect gear position information of a transmission to generate the sensing result SR3, and the parameter setting circuit 243 may determine a screen layout according to the sensing result SR3. Please refer to FIG. 2 and FIG. 3 together. FIG. 3 is a diagram illustrating an exemplary screen layout of the display unit 225 shown in FIG. 2 according to an embodiment of the present invention. In this embodiment, when the vehicle moves forward (e.g. the transmission gear is in a drive position), the display information processing circuit 241 may stitch the sub-images IMG_S1-IMG_S4 to generate a 360° AVM image, and synthesize a vehicle image IMG_V (stored in the storage unit 247) and the AVM image to generate a vehicular image IMG_VR, thereby displaying the vehicular display information INF_VD1 on the display unit 225 according to a display setting DS. When the driver shifts the transmission gear to a reverse position, the display setting DS generated by the parameter setting circuit 243 is a required single-picture or two/three-picture display setting (i.e. a single-window or multi-window display setting), wherein a display content of these display settings may include a 360° AVM image, a top-view image, etc. Hence, the display information processing circuit 241 may display vehicular display information INF_VD2 on the display unit 225 according to the display setting DS, wherein the vehicular display information INF_VD2 may include the vehicular image IMG_VR and a plurality of rear-view images IMG_G1 and IMG_G2. As a person skilled in the art should understand the operation of the screen layout adjustment using the gear position switching, further description is omitted here for brevity.

In view of the above description, the display information processing circuit 241 may output the vehicular display information INF_VD according to the sub-images IMG_S1-IMG_S4, the on-screen display information INF_OSD and the display setting DS, which may enable the display unit 225 to display a single-window picture or a multi-window picture, wherein the single-window/multi-window picture may include the display information such as the parking assist graphics, moving object detection and/or the vehicle speed. For brevity and clarity, the following description uses a single-window picture to illustrate one exemplary display control of a vehicular image.

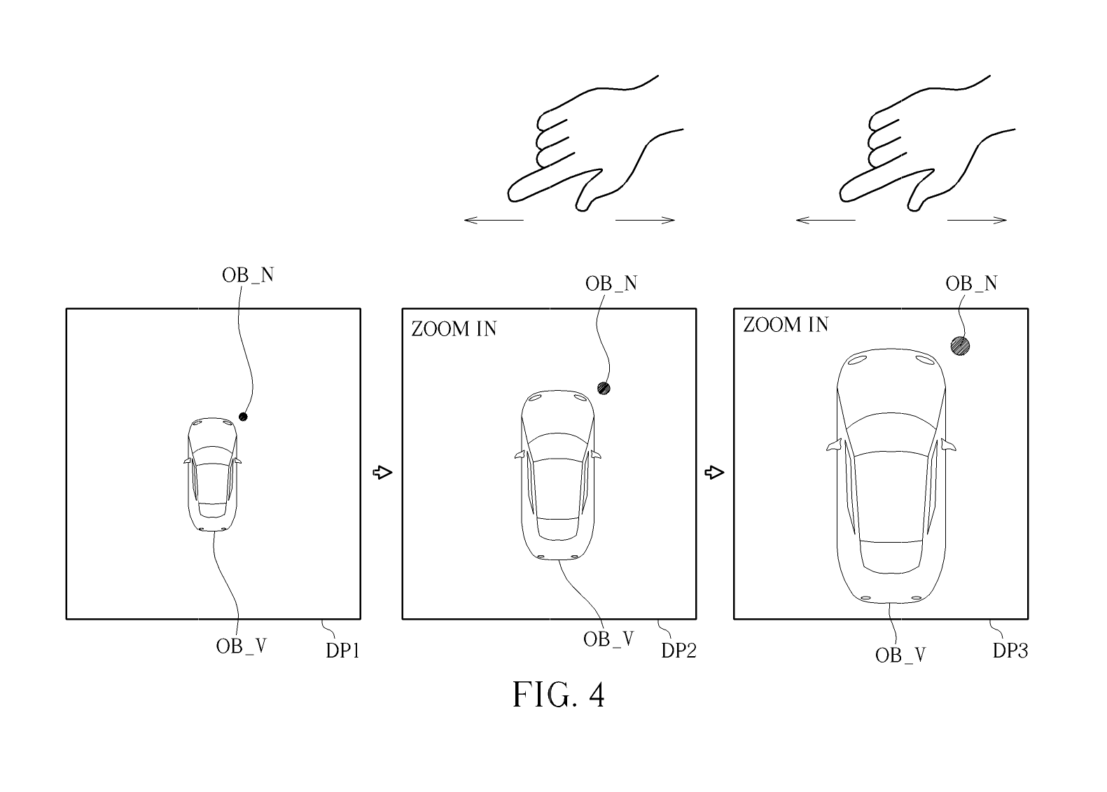

Please refer to FIG. 2 and FIG. 4 together. FIG. 4 is a diagram illustrating an exemplary display zoom-in/out control of a vehicular image according to a first embodiment of the present invention. In this embodiment, a default display DP1 shows a vehicle object OB_V and an unknown object OB_N. As the unknown object OB_N on the default display DP1 is so small the user has no idea of what is represented by the unknown object OB_N (e.g. an obstacle or a floor picture). The user may zoom in on the display of the vehicular image by a touch gesture or an optical sensing gesture which moves/spreads two fingers away from each other. In one implementation, the user may first drag (a touch gesture or an optical sensing gesture) an image area to be zoomed in to a center of the display, and then zoom in on the image area by moving two fingers away from each other (a touch gesture or an optical sensing gesture), thereby realizing the operation of “zooming in on the image locally”. In addition, the user may further bring two fingers together to zoom out the display of the vehicular image.

Taking an example of image magnification, after the touch panel 220 detects two fingers moving away from each other, the gesture recognition unit 230 may interpret an amount of finger movement as “a magnification factor of the vehicular image display”. In other words, the gesture recognition result GR may include a gesture command for adjusting the display of the vehicular image (i.e. a zoom-in command) and an adjustment parameter (i.e. the magnification factor). Next, the parameter setting circuit 243 may obtain the zoom-in command and the adjustment parameter, and the on-screen display and line generation unit 245 may obtain the zoom-in command from the gesture recognition unit 230. The parameter setting circuit 243 may generate the corresponding display setting DS to the display information processing circuit 241 according to the gesture recognition result GR and the gear position sensing result SR3 detected by the shift position sensor 265. The on-screen display and line generation unit 245 may generate the corresponding on-screen display information INF_OSD to the display information processing circuit 241 according to the zoom-in command. Hence, the display information processing circuit 241 may adjust the default display DP1 to a display DP2 according to the display setting DS and the on-screen display information INF_OSD (i.e. displaying the “zoom-in” command), wherein the display DP2 presents the word “ZOOM IN”, the magnified vehicle object OB_V and the magnified unknown object OB_N.

In this embodiment, the display information processing circuit 241 first generates a plurality of corrected images by performing a wide-angle distortion correction and a top-view transformation upon the sub-images IMG_S1-IMG_S4 according to the display setting DS, then performs the image magnification upon the corrected images, and finally stitches the magnified corrected images together to generate a magnified vehicular image. Controlling a display (e.g. a display mode and/or a view angle) of a vehicular image by performing a geometric transformation upon source images (i.e. the sub-images IMG_S1-IMG_S4) may avoid image information loss caused by performing geometric transformation directly upon the vehicular image, thereby providing the user with a good operating experience of two-dimensional/three-dimensional (2D/3D) vehicular image.

If the user still cannot identify the type of the unknown object OB_N due to insufficient magnification of the display DP2, the use may perform the image magnification again immediately. In order to enhance the identification efficiency and accuracy, the gesture command may be stored and a time interval between two continuous gestures may be measured for identifying touch information on the touch panel 220.

More specifically, when the fingers leave the touch panel 220 (the display DP1 has been adjusted to the display DP2), the gesture recognition 230 may further store the zoom-in command and the adjustment parameter, and start to measure a maintenance time for which the fingers have left the touch panel 220. If the user performs the image magnification again upon the touch panel 220 before the maintenance time exceeds a predetermined time (i.e. a display DP3), the gesture recognition unit 230 may merely interpret the magnification factor without transmitting the zoom-in command to the parameter setting circuit 243 and the on-screen display and line generation unit 245; otherwise, if the user does not perform the image magnification again upon the touch panel 220 before the maintenance time exceeds the predetermined time, the gesture recognition unit 230 may stop recognizing the touch information on the touch screen 220. Please note that the device which executes the above storage and measurement steps is not limited to the gesture recognition unit 230. For example, the processing unit 240 may be arranged to store the gesture command, measure the time interval between two continuous gestures, and stop recognition by not updating the vehicular display information INF_VD. In brief, any device having storage capability may be used to execute the above storage and measurement steps.

By performing the gestures on the touch panel 220, the user may readily confirm the type of the unknown object OB_N. For example, if the user is not sure which type of unknown object OB_N is represented, the user may zoom in on the display by performing intuitive gestures (e.g. touch operations) to thereby determine the unknown object OB_N. If the unknown object OB_N is an obstacle, the user may bypass the obstacle to enhance the traffic safety. If the unknown object OB_N is a child, the user may ensure the safety of the child. Please note that a person skilled in the art should understand that the gesture is not limited to the zoom-in command, and the zoom-in command is not limited to moving two fingers away from each other. In addition, if the vehicular image system 200 is employed in a security system of, for example, an armored cash carrier, the user may perform the zoom-in/zoom-out command to identify suspicious persons in the vicinity of the armored cash carrier, which may make the security system more robust. Moreover, as the processing unit 240 includes the storage unit 247, the vehicular image system 200 may be upgraded to an event data recorder (EDR) having image display control capability by integrating with the EDR.

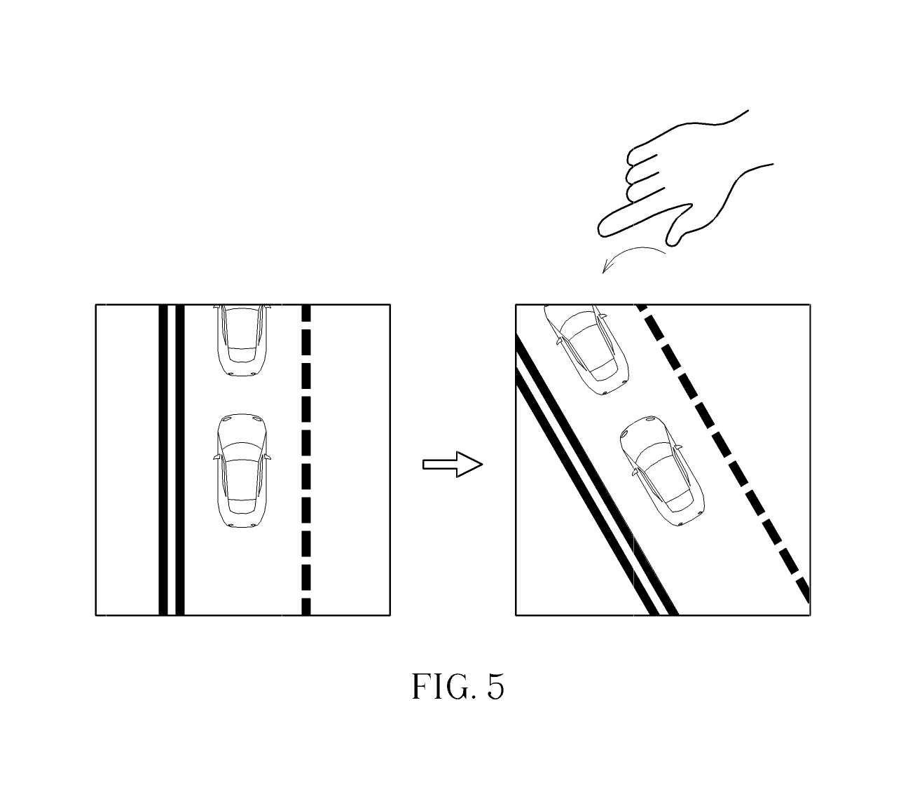

As mentioned above, the gesture command indicated by the gesture recognition result is not limited to the zoom command. The gesture command may be a rotation command, a shifting command, a tilt command or a viewing angle/position changing command, wherein the adjustment parameter is the amount of movement corresponding to the gesture command. Please refer to FIG. 5 in conjunction with FIG. 2. FIG. 5 is a diagram illustrating an exemplary display rotation control of a vehicular image according to a second embodiment of the present invention. In this embodiment, the user draws an arc on the touch panel 220 with his/her finger(s) in a counterclockwise direction. The gesture recognition result GR may indicate “rotate 30° counterclockwise”, wherein the gesture command is a counterclockwise rotation command and the adjustment parameter is 30°. Please note that, regarding functions of the gesture recognition unit 230, the gesture command is not limited to a single finger but may be performed by multiple fingers. The rotation command may be realized by drawing an arc with multiple fingers or rotating with one finger as a circle center and another finger as a point at a circumference.

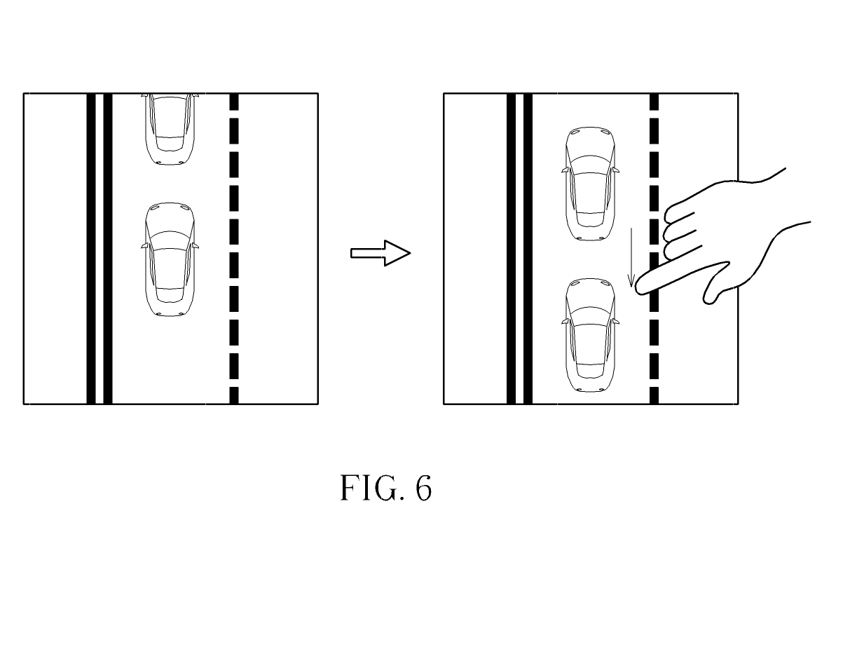

Please refer to FIG. 6 in conjunction with FIG. 2. FIG. 6 is a diagram illustrating an exemplary display shifting control of a vehicular image according to a third embodiment of the present invention. In this embodiment, the user's finger drags downward, and the gesture recognition result GR may indicate a downward shifting command. Please note that when the user's finger touches an object (e.g. a vehicle) on the display, the object may change color to inform the user that the object is selected.

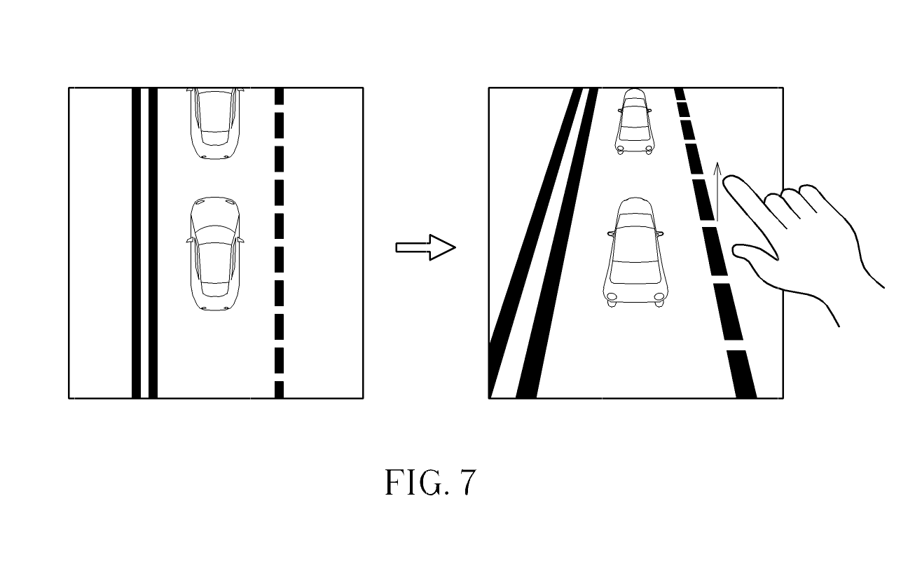

Please refer to FIG. 7 in conjunction with FIG. 2. FIG. 7 is a diagram illustrating an exemplary display tilt control of a vehicular image according to a fourth embodiment of the present invention. In this embodiment, the user's finger drags upward, and the gesture recognition result GR may indicate “tilt 30° forward”, wherein the gesture command is a tilt command and the adjustment parameter is 30°. In a preferred implementation, the display information processing circuit 241 may perform a tilt operation upon the sub-images IMG_S1-IMG_S4 according to the display setting DS, and then perform image stitching and image synthesis to change a viewing angle/position of the vehicular image. Please note that each vehicular image shown in FIGS. 3-7 may be a 2D vehicular image or a 3D vehicular image. Additionally, the user may perform a combination of the aforementioned gesture commands (e.g. performing a tilt command and a rotation command sequentially) according to the viewing requirements in order to control the display of the vehicular image.

Please refer to FIG. 1 and FIG. 2 again. The sensing receiving unit 120 shown in FIG. 1 may be implemented by the touch panel 220 shown in FIG. 2, and the processing unit 140 shown in FIG. 1 may be implemented by the display information processing circuit 241, the parameter setting circuit 243, the on-screen display and line generation unit 245 and the storage unit 247 shown in FIG. 2. Please note that the on-screen display and line generation unit 245 and the storage unit 247 are optional circuit units. The processing unit 140 shown in FIG. 1 may be implemented by the display information processing circuit 241 and the parameter setting circuit 243. Additionally, the display unit 225 may be integrated in the touch panel 220.

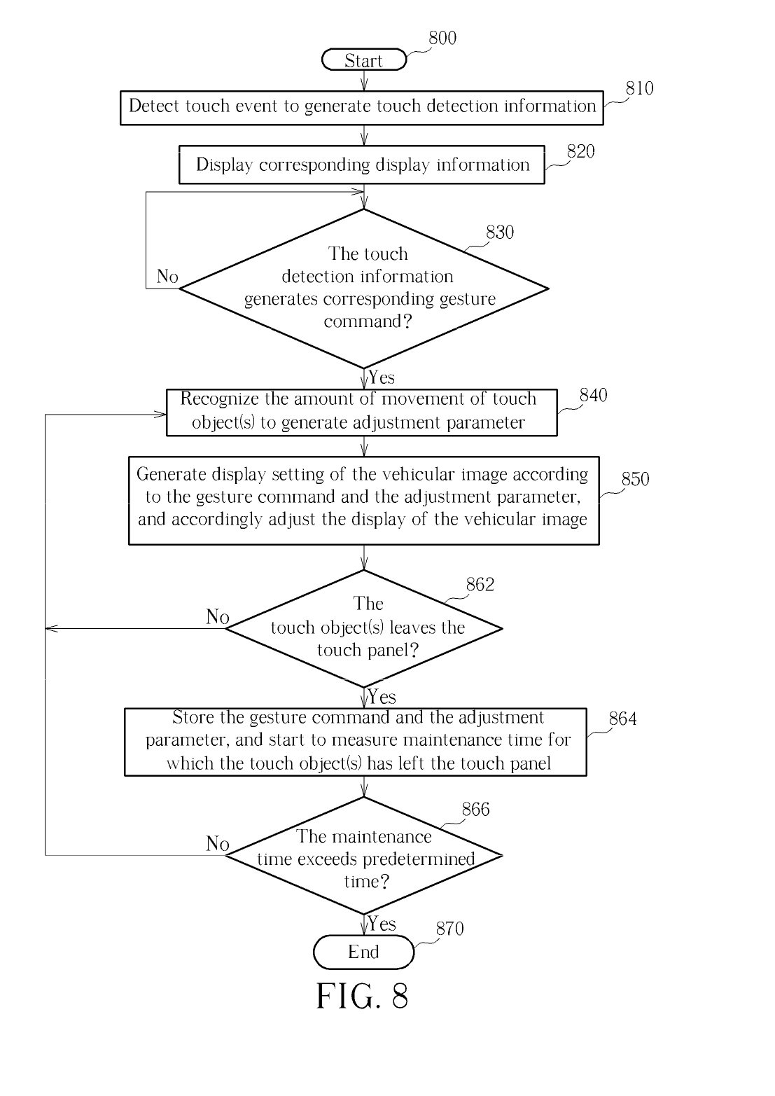

Please refer to FIG. 8, which is a flow chart of an exemplary display control method using a touch panel for a vehicular image according to an embodiment of the present invention. The vehicular image is synthesized by a plurality of sub-images (i.e. a plurality wide-angle distortion images). More specifically, a geometric correction may be performed upon the sub-images to generate a plurality of corrected images, and then the corrected images may be synthesized to generate the vehicular image. In one implementation, the corrected images may be synthesized to generate a 360° AVM image, and then the 360° AVM image and a vehicle image may be synthesized to generate the vehicular image. After the vehicular image is generated, the method shown in FIG. 8 may be employed to control a display of the vehicular image. Provided that the results are substantially the same, steps are not required to be executed in the exact order shown in FIG. 8. The method may be summarized as follows.

Step 800: Start.

Step 810: Detect a touch event occurring on the touch panel and accordingly generate touch detection information, wherein the touch detection information includes the number, the path of motion, and the amount of movement of touch object(s) on the touch panel.

Step 820: Display corresponding display information.

Step 830: Determine whether the touch detection information generates a corresponding gesture command. If yes, go to step 840; otherwise, repeat step 830.

Step 840: Recognize the amount of movement of the touch object(s) (e.g. a displacement vector, or an amount of rotation) to generate an adjustment parameter corresponding to the gesture command.

Step 850: Generate a display setting of the vehicular image according to the gesture command and the adjustment parameter, and accordingly adjust the display of the vehicular image.

Step 862: Determine whether the touch object(s) leaves the touch panel. If yes, go to step 864; otherwise, return to step 840.

Step 864: Store the gesture command and the adjustment parameter, and start to measure a maintenance time for which the touch object(s) has left the touch panel.

Step 866: Determine whether the maintenance time exceeds a predetermined time. If yes, go to step 870; otherwise, return to step 840.

Step 870: End.

In step 820, the flow may change the color of an image object which is selected in step 810. In step 830, when it is determined that the touch detection information does not generate the corresponding gesture command, the flow may repeat step 830 until the user operates the touch panel with a predefined gesture. Please note that the gesture command in step 830 and the adjustment parameter in step 840 may correspond to the gesture recognition result GR shown in FIG. 2. In step 862, when the touch object(s) maintains contact with the touch panel, it may imply that the user continuously operates the touch panel with the same gesture. Thus, the flow may repeat step 840 to keep recognizing the amount of movement of the touch object(s). In step 866, when the time for which the touch object(s) has left the touch panel does not exceed the predetermined time, this may imply that the user continuously operates the touch panel with the same gesture (i.e. the touch event occurs continuously). Thus, the flow may repeat step 840. As a person skilled in the art can readily understand the operation of each step shown in FIG. 8 after reading the paragraphs directed to FIGS. 1-7, further description is omitted here for brevity.

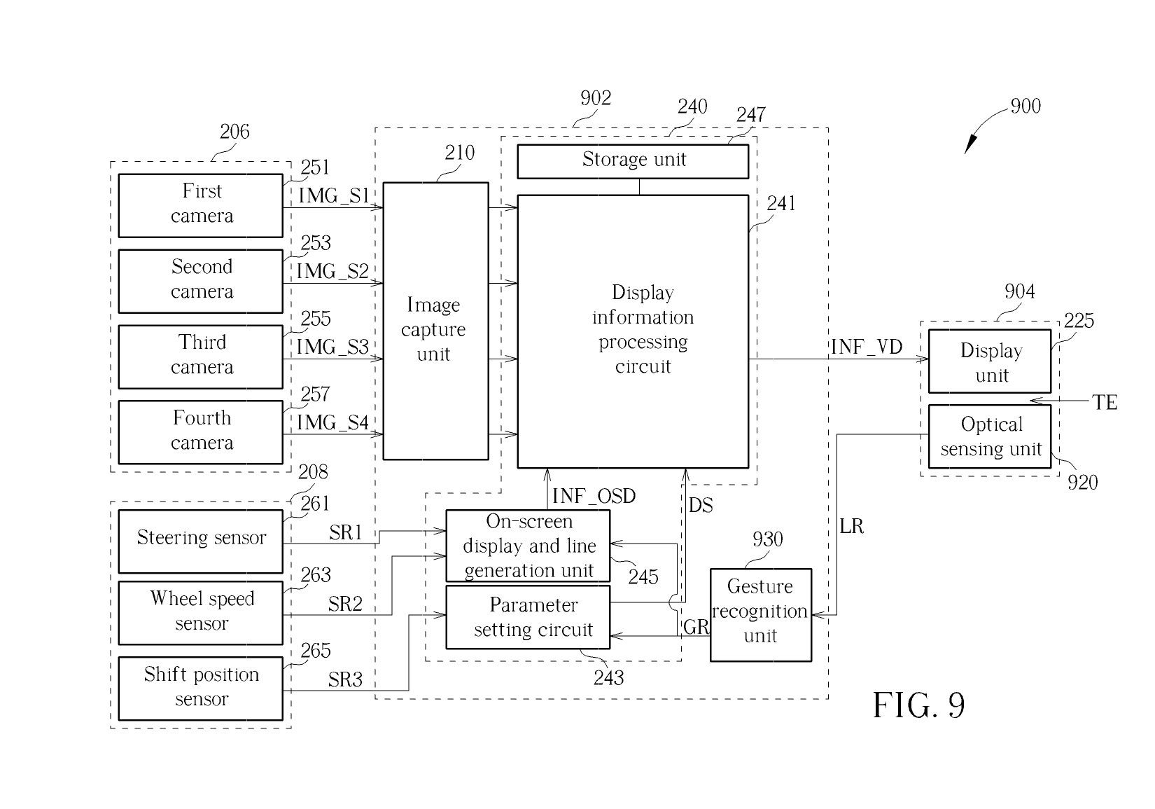

As mentioned above, the sensing receiving unit 120 shown in FIG. 1 may be a non-contact optical sensing receiving unit such as an infrared proximity sensor. Please refer to FIG. 9, which is a diagram illustrating an exemplary vehicular image system according to a second embodiment of the present invention. The architecture of the vehicular image system 900 shown in FIG. 9 is based on the vehicular image system 200 shown in FIG. 2, wherein the difference is that a human machine interface 904 includes an optical sensing unit 920 (e.g. an infrared proximity sensor), which may detect a user's gesture according to reflected light. Additionally, an ECU 902 includes a gesture recognition unit 930 which is arranged to recognize an optical sensing result LR. In this embodiment, the user may control a display of a vehicular image directly by a non-contact gesture, thereby facilitating the control of the vehicular image system 900. Please note that the non-contact sensing receiving unit is not limited to the optical sensing unit. For example, the optical sensing unit 920 may be replaced by a dynamic image capture apparatus (e.g. a camera). The dynamic image capture apparatus may capture a user's gesture image, and the corresponding gesture recognition unit may recognize the gesture image so that the processing unit may control the display of the vehicular image accordingly.

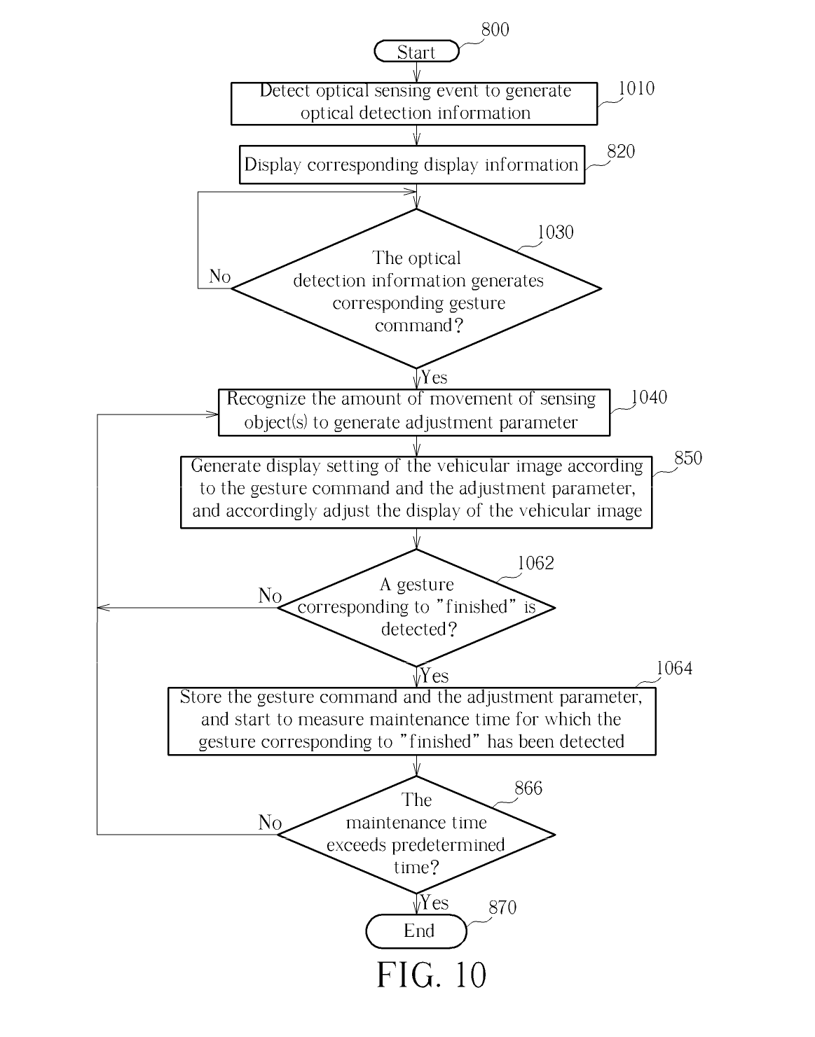

Please refer to FIG. 10, which is a flow chart of an exemplary display control method using an optical sensing unit for a vehicular image according to an embodiment of the present invention. The method shown in FIG. 10 is based on the method shown in FIG. 8, and may be summarized as follows.

Step 800: Start.

Step 1010: Detect an optical sensing event occurring on the optical sensing unit and accordingly generate optical detection information, wherein the optical detection information includes the number, the path of motion, and the amount of movement of sensing object(s) on the optical sensing unit.

Step 820: Display corresponding display information.

Step 1030: Determine whether the optical detection information generates a corresponding gesture command. If yes, go to step 1040; otherwise, repeat step 1030.

Step 1040: Recognize the amount of movement of the sensing object(s) (e.g. a displacement vector, or an amount of rotation) to generate an adjustment parameter corresponding to the gesture command,

Step 850: Generate a display setting of the vehicular image according to the gesture command and the adjustment parameter, and accordingly adjust the display of the vehicular image.

Step 1062: Determine whether a gesture corresponding to “finished” is detected. If yes, go to step 1064; otherwise, return to step 1040.

Step 1064: Store the gesture command and the adjustment parameter, and start to measure a maintenance time for which the gesture corresponding to “finished” has been detected.

Step 866: Determine whether the maintenance time exceeds a predetermined time. If yes, go to step 870; otherwise, return to step 1040.

Step 870: End.

As a person skilled in the art can readily understand the operation of each step shown in FIG. 10 after reading the paragraphs directed to FIGS. 1-9, further description is omitted here for brevity.

To sum up, the proposed vehicular image system may not only provide a convenient operating experience for the user but also provide display of objects from any view angle. The proposed vehicular image system may be installed in the vehicle with almost no additional cost and extra space requirement. In addition, the traffic safety is also enhanced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A vehicular image system, comprising:
a display unit;
an image capture unit, for receiving a plurality of sub-images;
a sensing receiving unit, for detecting a sensing event to generate detection information;
a gesture recognition unit, coupled to the sensing receiving unit, for generating a gesture recognition result according to the detection information; and
a processing unit, coupled to the image capture unit and the gesture recognition unit, for generating a vehicular image according to the sub-images and controlling a display of the vehicular image on the display unit according to the gesture recognition result.

2. The vehicular image system of claim 1, wherein the sensing receiving unit is a contact touch-receiving unit or a non-contact sensing receiving unit.

3. The vehicular image system of claim 1, wherein the gesture recognition result comprises a gesture command and an adjustment parameter which are used to adjust the display of the vehicular image.

4. The vehicular image system of claim 3, wherein the gesture command is a zoom-in command, a zoom-out command, a rotation command, a shifting command, a tilt command, a viewing angle changing command or a viewing position changing command.

5. The vehicular image system of claim 1, wherein the processing unit performs a geometric correction upon the sub-images to generate a plurality of respective corrected images, and synthesizes the corrected images to generate the vehicular image.

6. The vehicular image system of claim 1, wherein the processing unit performs a geometric transformation upon the sub-images according to the gesture recognition result, and synthesizes the transformed sub-images to control the display of the vehicular image on the display unit.

7. The vehicular image system of claim 6, wherein the geometric transformation is a zoom-in operation, a zoom-out operation, a rotation operation, a shifting operation, a tilt operation, a viewing angle changing operation or a viewing position changing operation.

8. The vehicular image system of claim 1, wherein the processing unit performs a geometric transformation directly upon the vehicular image according to the gesture recognition result in order to control the display of the vehicular image on the display unit.

9. The vehicular image system of claim 8, wherein the geometric transformation is a zoom-in operation, a zoom-out operation, a rotation operation, a shifting operation, a tilt operation, a viewing angle changing operation or a viewing position changing operation.

10. The vehicular image system of claim 1, wherein the processing unit comprises:
a parameter setting circuit, for generating a display setting of the vehicular image at least according to the gesture recognition result; and
a display information processing circuit, coupled to the parameter setting circuit, for controlling the display of the vehicular image on the display unit at least according to the display setting.

11. The vehicular image system of claim 10, further comprising:
a steering sensor, for detecting a turning angle to generate a first sensing result;
a wheel speed sensor, for detecting a wheel rotation speed to generate a second sensing result; and
a shift position sensor, coupled to the parameter setting circuit, for detecting gear position information to generate a third sensing result to the parameter setting circuit; and
the processing unit further comprises:
an on-screen display and line generation unit, coupled to the steering sensor, the wheel speed sensor and the display information processing circuit, for generating on-screen display information to the display information processing circuit according to the first sensing result and the second sensing result;
wherein the parameter setting circuit generates the display setting of the vehicular image further according to the third sensing result, and the display information processing circuit controls the display of the vehicular image on the display unit further according to the on-screen display information.

12. A display control method for a vehicular image, comprising:
receiving a plurality of sub-images;
generating the vehicular image according to the sub-images;
detecting a sensing event to generate detection information;
generating a gesture recognition result according to the detection information; and
controlling a display of the vehicular image according to the gesture recognition result.

13. The display control method of claim 12, wherein the sensing event is a contact touch event or a non-contact sensing event.

14. The display control method of claim 12, wherein the gesture recognition result comprises a gesture command and an adjustment parameter which are used to adjust the display of the vehicular image.

15. The display control method of claim 14, wherein the gesture command is a zoom-in command, a zoom-out command, a rotation command, a shifting command, a tilt command, a viewing angle changing command or a viewing position changing command.

16. The display control method of claim 14, wherein when the gesture recognition result indicates that the sensing event stops triggering, the method further comprises:
storing the gesture command and the adjustment parameter;
starting to measure a maintenance time for which the sensing event has stopped triggering; and
determining whether to stop recognizing the sensing event according to the maintenance time;
wherein when the maintenance time exceeds a predetermined time, it is determined to stop recognizing the sensing event, and when the maintenance time does not exceed the predetermined time, it is determined to continue recognizing the sensing event to update the adjustment parameter.

17. The display control method of claim 12, wherein the step of generating the vehicular image according to the sub-images comprises:
performing a geometric correction upon the sub-images to generate a plurality of respective corrected images; and
synthesizing the corrected images to generate the vehicular image.

18. The display control method of claim 12, wherein the step of controlling the display of the vehicular image according to the gesture recognition result comprises:
performing a geometric transformation upon the sub-images according to the gesture recognition result, and synthesizing the transformed sub-images to control the display of the vehicular image.

19. The display control method of claim 18, wherein the geometric transformation is a zoom-in operation, a zoom-out operation, a rotation operation, a shifting operation, a tilt operation, a viewing angle changing operation or a viewing position changing operation.

20. The display control method of claim 12, wherein the step of controlling the display of the vehicular image according to the gesture recognition result comprises:
performing a geometric transformation directly upon the vehicular image according to the gesture recognition result in order to control the display of the vehicular image.

21. The display control method of claim 20, wherein the geometric transformation is a zoom-in operation, a zoom-out operation, a rotation operation, a shifting operation, a tilt operation, a viewing angle changing operation or a viewing position changing operation.

22. The display control method of claim 12, wherein the step of controlling the display of the vehicular image according to the gesture recognition result comprises:
generating a display setting of the vehicular image according to the gesture recognition result; and
controlling the display of the vehicular image according to the display setting.
